(19) United States
(12) Patent Application Publication
(10) Pub. No.: US 2011/0071205 A1
(43) Pub. Date: Mar. 24, 2011

(54) Use of Cyclic Ketoenols Against Phytopathogenic Bacteria

(75) Inventor: Wolfgang THIELERT, Odenthal (DE)

(73) Assignee: Bayer CropScience AG, Monheim (DE)

(21) Appl. No.: 12/877,621

(22) Filed: Sep. 8, 2010

Related U.S. Application Data
(60) Provisional application No. 61/240,756, filed on Sep. 9, 2009.

(30) Foreign Application Priority Data
Sep. 9, 2009 (EP) 09169845.6

(51) Int. Cl. A01N 43/38; A01P 1/00

(52) U.S. Cl. 514/409

(57) ABSTRACT

The present invention relates to the use of known cyclic ketoenols against phytopathogenic bacteria.

The present invention relates to the use of known cyclic ketoenols against phytopathogenic bacteria.

The gram-negative bacteria Candidatus Liberibacter asiaticus, Candidatus Liberibacter americanus, Candidatus Liberibacter africanus and Candidatus Liberibacter africanus ssp. Capensis, which as yet cannot be cultivated in vitro, cause the citrus disease HLB (huanglongbing), which is also referred to by the English trivial name “citrus greening” a severe bacteriosis which is a serious threat to citrus production all over the world (Josy Bové, 2008: A destructive, newly-emerging, century-old disease in citrus: huanglongbing in Africa, Asia and America. History, causal agents, transmission, distribution, and symptoms. Control or no control, success or failure?; Proceedings of the 5^{th} International Citrus Research Symposium, 2008—Central Drakensberg, Republic of South Africa. p. 57-60). The bacterium belongs to the alpha subdivision of the Proteobacteriae which use the citrus psyllids Diaphorina citri (C.L.asiaticus, C.L.americanus, C.L.africanus) and Trioza erytreae (C.L.africanus, C.L.asiaticus) as vectors; they are limited to the phloem.

The appearance of the disease varies slightly depending on the citrus species; however, frequent symptoms of the disease are a yellowing of the leaf veins and the adjacent tissues and subsequent yellowing or mottling of the entire leaf. At an advanced stage of the disease in trees or in chronically infected trees, the entire crown of the tree is yellowed and thinned out, and branches are dying off. Diseased trees form small irregular fruits which remain mostly green even when mature and are deformed, most of the seeds are stunted and the juice has a low mineral content and a high acid content, which renders it unfit for consumption owing to its bitter-salty taste.

Infected trees do not recover. The control of HLB is based on the preventive control of the vectors using systemic insecticides and contact insecticides. However, the efficacy and activity spectrum of these compounds are not always completely satisfactory. Newly infected trees show the first symptoms after a latency period of 6-12 months. In addition, it is essential to eradicate infected trees to prevent further uptake by psyllids and spreading of the disease.

HLB bacteria live and multiply exclusively in the phloem of citrus trees. Hitherto, there arc however no bactericides for the curative control of HLR. However, the ketoenol ACCase inhibitor spirotetramat (compound of the formula (1-2)) with its phloem-mobile and biologically active metabolite spirotetramat-enol (compound of the formula (1-1)) is active not only against various sucking pests including HLB disease vectors, but also against fungal pathogens (WO 06/077071, WO 07/131681, WO 07/126691, WO 07/144086, WO 08/017388, WO 08/080545, WO 09/000443, WO 09/003597, WO 09/085176, WO 09/083132, PCT/EP/2009/000816 (not yet published)) and in particular against bacteria which live exclusively in the phloem, such as Candidatus Liberibacter species in citrus.

It has now been found that compounds of the formula (I-1) or (I-2)

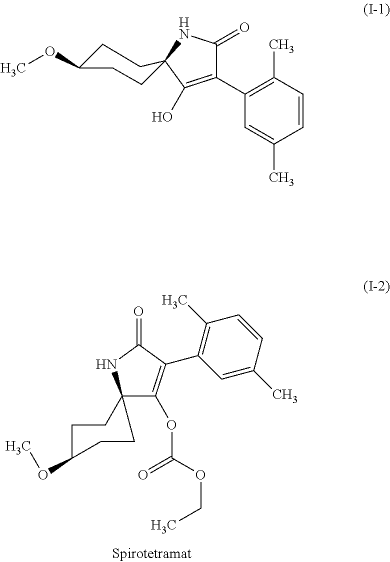

are suitable for the control of bacteria, preferably phytopathogenic bacteria, and in particular bacteria such as Candidatus Liberibacter species in citrus which live exclusively in the phloem. Application is by spraying and by suil application.

The active compounds of the formulae (1-1) and (1-2) and their insecticidal and/or acaricidal action are known fom: WO 98/05638, WO 04/007448.

The active compounds, which are tolerated well by plants, are suitable for controlling bacterioses encountered in the cultivation of fruit, in agriculture, in nurseries and in forests. They may be preferably employed as crop protection agents. They are active against normally sensitive and resistant species and also against all or some stages of development.

The abovementioned bacteria include: Candidatus Liberibacter asiaticus, Candidatus Liberibacter americanus, Candidatus Liberibacter africanus, Candidatus Liberibacter africanus ssp. Capensis.

Regarding the use, perennial crops are understood as meaning citrus, such as, for example, oranges, grapefruits, tangerines, lemons, limes, Seville oranges, kumquats, satsumas, etc.

All plants and plant parts can be treated in accordance with the invention. By plants are understood here all plants and plant populations such as desired and undesired wild plants or crop plants (including naturally occurring crop plants). Crop plants can be plants which can be obtained by conventional breeding and optimization methods or by biotechnological and genetic engineering methods or combinations of these methods, including the transgenic plants and including the plant varieties which can or cannot be protected by varietal property rights. Parts of plants are to be understood as meaning all above-ground and below-ground parts and organs of plants, such as shoot, leaf, flower and root, examples which may be mentioned being leaves, needles, stems, trunks, flowers, fruit-bodies, fruits and seed, and also roots. The plant parts also include harvested material and also vegetative and generative propagation material, for example cuttings, slips and seed.

The treatment according to the invention of the plants and plant parts with the active compounds is carried out directly or by action on their environment and habitat using customary treatment methods, for example by watering and spraying.

As already mentioned above, it is possible to treat all plants and their parts according to the invention. In a preferred embodiment, wild plant species and plant cultivars, or those obtained by conventional biological breeding, such as crossing or protoplast fusion, and also parts thereof, are treated. In a further preferred embodiment, transgenic plants and plant cultivars obtained by genetic engineering, if appropriate in combination with conventional methods (Genetically Modified Organisms), and parts thereof are treated. The term “parts” or “parts of plants” or “plant parts” has been explained above.

Particularly preferably, plants of the plant cultivars which are in each case commercially available or in use are treated according to the invention. Plant cultivars are to he understood as meaning plants having new properties (“traits”) and which have been obtained by conventional breeding, by mutagenesis or by recombinant DNA techniques. They can be cultivars, biotypes or genotypes.

Depending on the plant species or plant cultivars, their location and growth conditions (soils, climate, vegetation period, nutrition), the treatment according to the invention may also result in superadditive (“synergistic”) effects. Thus possible are, for example, reduced application rates and/or a widening of the activity spectrum and/or an increase of the activity of the compounds and compositions usable according to the invention, better plant growth, increased tolerance to high or low temperatures, increased tolerance to drought or to water or soil salt content, increased flowering, easier harvesting, accelerated maturation, higher harvest yields, higher quality and/or higher nutrient value of the harvested products, increased storability and/or processability of the harvested products, which exceed the effects normally to be expected.

The preferred transgenic plants or plant cultivars (i.e. those obtained by genetic engineering) which are to be treated according to the invention include all plants which, in the genetic modification, received genetic material which imparted particularly advantageous useful properties (“traits”) to these plants. Examples of such properties are better plant growth, increased tolerance to high or low temperatures, increased tolerance to drought or to water or soil salt content, increased flowering, easier harvesting, accelerated maturation, higher harvest yields, higher quality and/or a higher nutritional value of the harvested products, better storability and/or processability of the harvested products. Further and particularly emphasized examples of such properties are a better defence of the plants against animal and microbial pests, such as against insects, mites, phytopathogenic fungi, bacteria and/or viruses, and also increased tolerance of the plants to certain herbicidally active compounds. Examples of transgenic plants which may be mentioned are the important crop plants, such as cereals (wheat, rice), maize, soy beans, potatoes, sugar beet, tomatoes, peas and other types of vegetable, cotton, tobacco, oilseed rape and also fruit plants (with the fruits apples, pears, citrus fruits and grapes), in particular emphasis is given to maize, soy beans, potatoes, cotton, tobacco and oilseed rape. Traits that are emphasized in particular are increased defence of the plants against insects, arachnids, nematodes and slugs and snails by toxins formed in the plants. in particular those formed in the plants by the genetic material from Bacillus thuringiensis (for example by the genes CryIA(a), CryIA(b), CryIA(c), CryIIA, CryIIIA, CryIIIB2, Cry9c Cry2Ab, Cry3Bb and CryIF and also combinations thereof) (hereinbelow referred to as “Bt plants”). Traits that are also particularly emphasized are the increased defence of the plants against fungi, bacteria and viruses by systemic acquired resistance (SAR), systemin, phytoalexins, elicitors and also resistance genes and correspondingly expressed proteins and toxins. Traits that are furthermore particularly emphasized are the increased tolerance of the plants to certain herbicidally active compounds, for example imidazolinones, sulfonylureas, glyphosate or phosphinothricin (for example the “PAT” gene). The genes which impart the desired traits in question can also be present in combinations with one another in the transgenic plants.

The active compounds can be converted into the customary formulations, such as solutions, emulsions, wettable powders, water- and oil-based suspensions, powders, dusts, pastes, soluble powders, soluble granules, granules for broadcasting, suspoemulsion concentrates, natural compounds impregnated with active compound, synthetic substances impregnated with active compound, fertilizers and also microencapsulations in polymeric substances.

These formulations are produced in a known manner, for example by mixing the active compounds with extenders, that is, liquid solvents and/or solid carriers, optionally with the use of surfactants, that is to say emulsifiers and/or dispersants and/or foam-formers. The formulations are prepared either in suitable facilities or else before or during application.

Suitable for use as auxiliaries are substances which arc suitable for imparting to the composition itself and/or to preparations derived therefrom (for example spray liquors, seed dressings) particular properties such as certain technical properties and/or also particular biological properties. Typical suitable auxiliaries are: extenders, solvents and carriers.

Suitable extenders are, for example, water, polar and nonpolar organic chemical liquids, for example from the classes of the aromatic and non-aromatic hydrocarbons (such as paraffins, alkylbenzenes, alkylnaphthalencs, chlorobenzenes), the alcohols and polyols (which, if appropriate, may also be substituted, etherified and/or esterified), the ketones (such as acetone, cyclohexanone), esters (including fats, and oils) and (poly)cthers, the unsubstituted and substituted amines, amides, lactams (such as N-alkylpyrrolidones) and lactones, the sulphones and sulphoxides (such as dimethyl sulphoxide).

If the extender used is water, it is also possible to employ, for example, organic solvents as auxiliary solvents. Essentially, suitable liquid solvents are: aromatics such as xylene, toluene or al kylnaphthalenes, chlorinated aromatics and chlorinated aliphatic hydrocarbons such as chlorobenzenes, chloroethylenes or methylene chloride, aliphatic hydrocarbons Such as cyclohexane or paraffins, for example petroleum fractions, mineral and vegetable oils, alcohols such as butanol or glycol and also their ethers and esters, ketones such as acetone, methyl ethyl ketone, methyl isobutyl ketone or cyclohcxanone, strongly polar solvents such as dimethyl sulphoxide, and also water.

Suitable solid carriers are:

for example ammonium salts and ground natural minerals such as kaolins, clays, talc, chalk, quartz, attapulgite, montmorillonite or diatomaceous earth, and ground synthetic materials such as highly disperse silica, alumina and silicates; suitable solid carriers for granules are: for example, crushed and fractionated natural rocks such as calcite, marble, pumice, sepiolite and dolomite, and also synthetic granules of inorganic and organic meals, and also granules of organic material such as paper, sawdust, coconut shells, maize cobs and tobacco stalks; suitable emulsifiers and/or foam-formers are: for example, nonionic and anionic emulsifiers, such as polyoxyethylene fatty acid esters, polyoxyethylene fatty alcohol ethers, for example alkylaryl polyglycol ethers, alkylsulphonates, alkyl sulphates, arylsulphonates and also protein hydrolysates; suitable dispersants are nonionic and/or ionic substances, for example from the classes of the alcohol-POE and/or -POP ethers, acid and/or POP POE esters, alkylaryl and/or POP POE ethers; fat and/or POP POE adducts, POE- and/or POP-polyol derivatives, POE- and/or POP-sorbitan or -sugar adducts, alkyl or aryl sulphates, alkyl- or arylsulphonates and alkyl or aryl phosphates or the corresponding PO-ether adducts. Furthermore, suitable oligomers or polymers, for example those derived from vinylic monomers, from acrylic acid, from EO and/or PO alone or in combination with, for example, (poly)alcohols or (poly)amines. It is also possible to employ lignin and its sulphonic acid derivatives, unmodified and modified cclluloscs, aromatic and/or aliphatic sulphonic acids and also their adducts with formaldehyde.

Tackifiers such as carboxymethylcellulose and natural and synthetic polymers in the form of powders, granules or latices, such as gum arabic, polyvinyl alcohol and polyvinyl acetate, as well as natural phospholipids such as cephalins and lecithins, and synthetic phospholipids, can be used in the formulations.

It is possible to use colorants such as inorganic pigments, for example iron oxide, titanium oxide and Prussian Blue, and organic colorants such as alizarin colorants, azo colorants and metal phthalocyanine colorants, and trace nutrients such as salts of iron, manganese, boron, copper, cobalt, molybdenum and zinc.

Other possible additives are perfumes, mineral or vegetable oils which are optionally modified, waxes and nutrients (including trace nutrients), such as salts of iron, manganese, boron, copper, cobalt, molybdenum and zinc.

Stabilizers, such as low-temperature stabilizers, preservatives, antioxidants, light stabilizers or other agents which improve chemical and/or physical stability, may also be present.

The formulations generally comprise between 0.01 and 98% by weight of active compound, preferably between 0.5 and 90%.

The active compounds can be present in commercially available formulations and also in the use forms, prepared from these formulations, as a mixture with other active compounds, such as insecticides, attractants, sterilizing agents, bactericides, acaricides, nematicides, fungicides, growth-regulating substances, herbicides, safeners, fertilizers or semiochemicals.

The active compound content of the use forms prepared from the commercially available formulations can vary within wide limits. The active compound concentration of the use forms can be from 0.0000001 to 95% by weight of active compound, preferably between 0.0001 and 1% by weight.

The compounds are employed in a customary manner appropriate for the use forms.

The good bactericidal action of the active compounds can be seen from the examples which follow.

### USE EXAMPLES

### Example 1

Nursery citrus plants are artificially inoculated with HLB (by oculation with HLB-infected material) to ensure a uniform infection rate in all trees. In this experiment, the efficacy of the products applied on the HLB-infected nursery plants is determined.

Fifty nursery plants of the cultivar Midnight Valencia are inoculated on a trifoliata hybrid substrate. The trees are transplanted into a potting soil mixture (gassed topsoil/bark mixture) in 5 containers. HLB-infected scions (at least two scions per plant) are then grafted onto the trees. The variants arc arranged in the form of a randomized block, with 10 repetitions. For the entire duration of the experiment, the irrigation, fertilization and insect control measures customary in practice are carried out.

Immediately after confirmation of the HLB infection of the trees by PCR analysis and after the entire new growth has been found to be HLB-positive in the test, the products are applied by foliar application to runoff point using a knapsack sprayer.

An infected untreated control is compared with a control treated with Movento* SC 240 (application rate 20 ml+300 ml/100 l of water; foliar application).

spirotetramat (compound of the formula (I-2))

The following parameters are evaluated:
Visual assessment of the leaves—blotchy mottling, leaf vein yellowing or other symptoms of deficiency, yellow shoots.
Length of shoots at two-week intervals
Circumference of the trunk once every month (first value measured prior to the oculation).
First PCR analysis (to ensure that the entire oculation material is positive).
Second PCR analysis (removal of leaves, 3 months after the oculation to determine the condition of the trees after grafting),
Third PCR analysis (removal of leaves, 6 months after the application of the chemicals to determine the effect of the treatment).
Final PCR analysis (removal of leaves, 12 months after the treatments; this indicates the final effect of the products applied on the disease and also whether a single treatment is sufficient for the control of HLB).
Final data analysis/assessment and conclusion of the experiment (12 months after application of the products): total mass of the above-ground shoots, wet root mass and dry root mass.
The fine roots are assessed visually using the proposed scoring scheme below:
   0—Healthy roots.
   1—Inhibition of fine-root growth (50%).
   2—Massive inhibition of fine roots (>70%).

1. A method, comprising the step of applying a compound of formula (I-1) or (I-2) 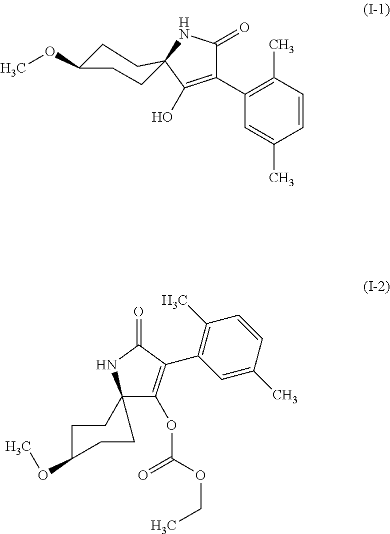
to a plant or a plant part in an amount effective for controlling bacteria.

2. A method, comprising the step of applying a compound of formula (I-1) or (I-2) according to claim 1 to a plant or a plant part in an amount effective for controlling Candidatus Liberibacter species as HLB bacterioses pathogens.

3. A method, comprising the step of applying a compound of formula (I-1) or (I-2) according to claim 1 to a plant or a plant part in an amount effective for controlling Candidatus Liberibacter asiaticus, Candidatus Liberibacter americanus, Candidatus Liberibacter africanus, Candidatus Liberibacter africanus spp. Capensis.

4. A method, comprising the step of applying a compound of formula (I-1) or (I-2) according to claim 1 to a citrus plants.
